(19) United States
(12) Patent Application Publication
(10) Pub. No.: US 2008/0006372 A1
(43) Pub. Date: Jan. 10, 2008

(54) Curtain strips for door ways to control temperature

(76) Inventor: David L. Beasley, Spring Valley, CA (US)

Correspondence Address: SUNG I. OH, PROFESSIONAL LAW CORPORATION, 710 QUAIL VALLEY LANE, WEST COVINA, CA, 91791, US

(21) Appl. No.: 11/481,785

(22) Filed: Jul. 6, 2006

(51) Int. Cl. E05D 15/00

(52) U.S. Cl. 160/184

(57) ABSTRACT

An interior room of a building is isolated from adjacent areas while permitting easy access to the interior room through the doorway of that room. A curtain-type doorway covering which includes a plurality of flexible strips pendently supported from a support element is mounted on a top of the doorway with movement through the doorway being permitted while the room is isolated from adjacent areas.

### TECHNICAL FIELD OF THE INVENTION

The present invention relates to the general art of static structures, and to the particular field of doorway coverings.

### BACKGROUND OF THE INVENTION

As is well known, people, in particular children, tend to move into and out of interior rooms with great frequency. If a room is cooled by a room air conditioner, the cooling effect is maintained by keeping the room isolated from adjacent areas. This isolation is best effected by keeping the door to the room closed. However, the cooling effect will be significantly vitiated by such frequent movement due to the frequent opening and closing of the door. Not only will the isolation be interrupted, the opening and closing of the door will create a convective heat transfer effect which will still further degrade the cooling effect. Therefore, there is need for a method for isolating an interior room from adjacent areas while still permitting easy and frequent access to the interior room.

Particularly with the increase in heating cost it has become common for commercial garages to use weather barriers that will separate around a vehicle entering the garage and close behind it without the necessity of opening a full door and closing it. Such weather barriers are commonly made of strips of plastic secured together along an edge from which they are hung. It has been known to make such weather barriers with two sheets of plastic sliced into strips at their lower ends and arranged so that the slit separations in one sheet are positioned over a center of a strip in the other sheet. Commonly the weather barriers are made in one layer of one sheet or of two or more layers each made with separate sheets of plastic. Sometimes each strip is made entirely separately.

While these barriers seem to work well for covering an outside access door, the inventor is not aware of any use being made of such barrier to isolate an interior room from adjacent areas.

### SUMMARY OF THE INVENTION

The above-discussed disadvantages of the prior art are overcome by using a plurality of flexible panels pendently supported from a support element mounted on top of a doorway of an interior room of a building and isolating that interior room from adjacent areas, such as adjacent rooms, to maintain control of the ambient temperature in that interior room while still allowing easy access to and egress from the interior room.

Other systems, methods, features, and advantages of the invention will be, or will become, apparent to one with skill in the art upon examination of the following figures and detailed description. It is intended that all such additional systems, methods, features, and advantages be included within this description, be within the scope of the invention, and be protected by the following claims.

### BRIEF DESCRIPTION OF THE DRAWING FIGURES

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a perspective view of a curtain-type element used in the method embodying the present invention.

FIG. 2 is a perspective view of top portion of the curtain-type element used in the method embodying the present invention.

### DETAILED DESCRIPTION OF THE INVENTION

Referring to the figures, it can be understood that the present invention is embodied in a method of isolating one interior room from adjacent interior areas of a static structure. The method comprises mounting a support element 10 on a wall 12 superadjacent to a doorway 14 of an interior room 16 of a static structure such as a home or the like.

A plurality of transparent planar flexible strips, such as strip 20, is provided and each planar flexible strip of the plurality of planar flexible strips is attached to the support element at one end 22 of each planar flexible strip. The support element can include two elongate strips 24 and 26 with the flexible strips being sandwiched between the strips 24 and 26 and held in place by fasteners 30 accommodated in fastener-receiving holes 32. A spacer 34 can be included.

The planar flexible strips can be formed of plastic material and are oriented to pendently hang from the support element to cover the doorway with the plurality of planar flexible strips. A bottom end 36 of each strip touches floor 40 associated with the doorway. The planar flexible strips are positioned so that each planar flexible strip overlaps at least one adjacent planar flexible strip as indicated in FIG. 2 at overlap 44 for adjacent strips 20′ and 20″. The overlapping feature ensures that interior room 16 will be isolated from adjacent areas by the flexible strips.

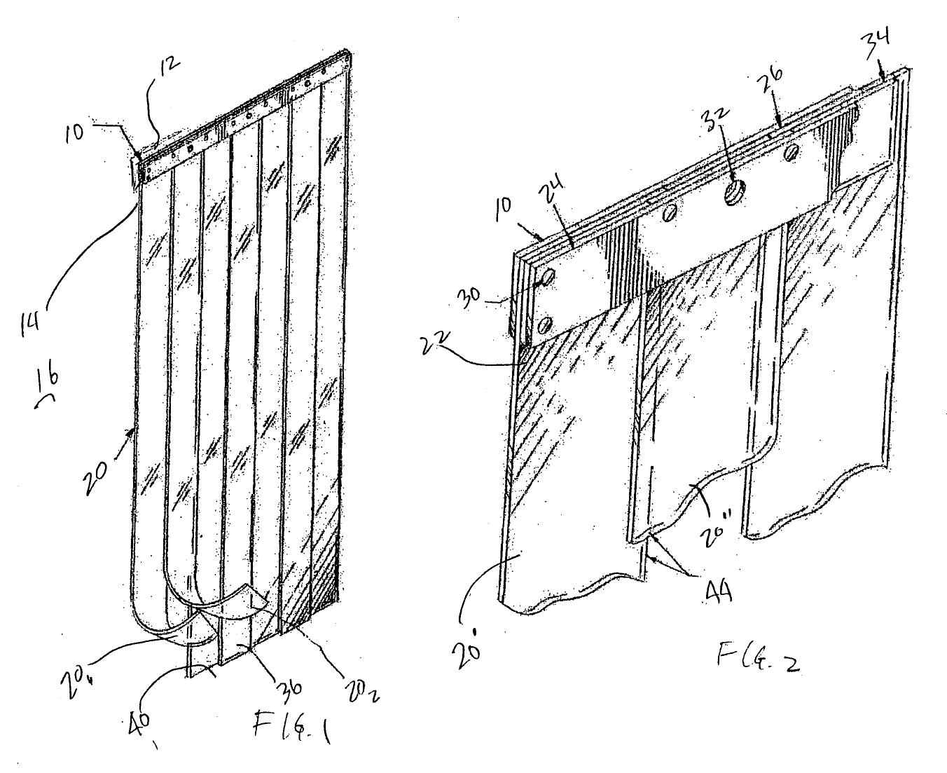

At least one of the planar flexible strips is moved as indicated in FIG. 1 for strips 20₁ and 20₂ away from a covering position to permit passage through the doorway. The strips will maintain desired ambient conditions in the interior room while permitting easy passage into and out of the room.

While various embodiments of the invention have been described, it will be apparent to those of ordinary skill in the art that many more embodiments and implementations are possible within the scope of this invention. Accordingly, the invention is not to be restricted except in light of the attached claims and their equivalents.

What is claimed is:

1. A method of isolating one interior room from adjacent interior areas of a static structure comprising:
A) mounting a support element on a wall superadjacent to a doorway of an interior room of a static structure;
B) providing a plurality of transparent planar flexible strips;
C) attaching each planar flexible strip of the plurality of planar flexible strips to the support element at one end of each planar flexible strip;
D) orienting the planar flexible strips to pendently hang from the support element;
E) covering the doorway with the plurality of planar flexible strips and causing each of the planar flexible strips to touch the floor associated with the doorway;
F) positioning the planar flexible strips so that each planar flexible strip overlaps at least one adjacent planar flexible strip; and
F) moving at least one of the planar flexible strips away from a covering position and permitting passage through the doorway.

2. The method defined in claim 1 wherein the planar flexible strips are plastic.
